(19) United States
(12) Patent Application Publication
(10) Pub. No.: US 2026/0058598 A1
(43) Pub. Date: Feb. 26, 2026

(54) SOLAR POWERED UNIVERSAL SERIAL BUS (USB) CHARGER IN AN INFLATABLE

(71) Applicant: Goodrich Corporation, Charlotte, NC (US)

(72) Inventors: Sparsh Agarwal, Kolkata (IN); Bhavamanyu Aman Saxena, Bangalore (IN)

(73) Assignee: Goodrich Corporation, Charlotte, NC (US)

(21) Appl. No.: 19/251,307

(22) Filed: Jun. 26, 2025

(30) Foreign Application Priority Data
Aug. 21, 2024 (IN) 202441063159

(51) Int. Cl. H02S 20/30; B63C 9/04; B64D 25/14; H02S 10/40; H02S 40/20; H02S 40/34

(52) U.S. Cl. CPC H02S 20/30; B63C 9/04; B64D 25/14; H02S 10/40; H02S 40/20; H02S 40/34; B63C 2009/042

(57) ABSTRACT

A life raft is provided. The life raft includes at least one inflatable tube, an inflatable canopy support tube coupled to the at least one inflatable tube, and a solar powered universal serial bus (USB) charger. The solar powered USB charger is coupled to the inflatable canopy support tube. The solar powered USB charger is configured to store a charge by being exposed to sunlight. The solar powered USB charger is configured to charge a mobile device responsive to being connected to the mobile device.

### CROSS-REFERENCE TO RELATED APPLICATIONS

This application claims priority to, and the benefit of, India Patent Application No. 202441063159, filed Aug. 21, 2024 (DAS Code 5F1E) and titled “SOLAR POWERED UNIVERSAL SERIAL BUS (USB) CHARGER IN AN INFLATABLE,” which is incorporated by reference herein in its entirety for all purposes.

### FIELD

The present disclosure generally relates to the field of inflatable assemblies and, more particularly, to a solar powered universal serial bus (USB) charger in an inflatable

### BACKGROUND

Aircraft emergency evacuation systems may often include inflatables. These inflatables may be inflated in an event of an emergency using an inflation system. In that regard, in an event of an emergency water landing, aircraft typically have one or more inflatable that may be deployed to hold evacuated passengers.

### SUMMARY

A life raft is disclosed. The life raft includes at least one inflatable tube, an inflatable canopy support tube, and a solar powered universal serial bus (USB) charger. The inflatable canopy support tube is coupled to the at least one inflatable tube. The solar powered USB charger coupled to the inflatable canopy support tube. The solar powered USB charger is configured to store a charge by being exposed to sunlight. The solar powered USB charger is configured to charge a mobile device responsive to being connected to the mobile device.

In various embodiments, the life raft further includes a first pouch. In various embodiments, the first pouch is coupled to an upper, unobstructed portion of the inflatable canopy support tube. In various embodiments, the first pouch is configured to house the solar powered USB charger.

In various embodiments, the first pouch is at least one of a weather-resistant pouch or a weatherproof pouch.

In various embodiments, responsive to the first pouch being a first weather-resistant pouch, the solar powered USB charger is accessible via a flap. In various embodiments, the flap is configured to provide weather-resistance when sealed via a seal.

In various embodiments, the seal is at least one of a weather-resistant hook and loop mechanism or a weather-resistant zipper mechanism.

In various embodiments, responsive to the first pouch being the weatherproof pouch, a first end of a USB extension cord is coupled to the solar powered USB charger and, once the solar powered USB charger is placed in the weatherproof pouch, the weatherproof pouch is hermetically sealed leaving a second end of the USB extension cord accessible.

In various embodiments, the life raft further includes a second pouch. In various embodiments, the second pouch is coupled to an accessible portion of the at least one inflatable tube. In various embodiments, the second pouch is configured to store the second end of the USB extension cord.

In various embodiments, the second pouch is a second weather-resistant pouch.

In various embodiments, the first pouch includes a transparent plastic film or window configured to, once the solar powered USB charger is placed inside, expose photovoltaic cells of the solar powered USB charger to the sunlight.

In various embodiments, the solar powered USB charger is coupled to an upper, unobstructed portion of the inflatable canopy support tube.

Also disclosed herein is an evacuation slide. The evacuation slide includes at least one inflatable tube and a solar powered universal serial bus (USB) charger. The solar powered USB charger is coupled to one of the at least one inflatable tube. The solar powered USB charger is configured to store a charge by being exposed to sunlight, The solar powered USB charger is configured to charge a mobile device responsive to being connected to the mobile device.

In various embodiments, the evacuation slide further includes a first pouch. In various embodiments, the first pouch is coupled to an upper, unobstructed portion of the at least one inflatable tube. In various embodiments, the first pouch is configured to house the solar powered USB charger.

In various embodiments, the first pouch is at least one of a weather-resistant pouch or a weatherproof pouch.

In various embodiments, responsive to the first pouch being a first weather-resistant pouch, the solar powered USB charger is accessible via a flap. In various embodiments, the flap is configured to provide weather-resistance when sealed via a seal.

In various embodiments, the seal is at least one of a weather-resistant hook and loop mechanism or a weather-resistant zipper mechanism.

In various embodiments, responsive to the first pouch being the weatherproof pouch, a first end of a USB extension cord is coupled to the solar powered USB charger and, once the solar powered USB charger is placed in the weatherproof pouch, the weatherproof pouch is hermetically sealed leaving a second end of the USB extension cord accessible.

In various embodiments, the evacuation slide further includes a second pouch. In various embodiments, the second pouch is coupled to an accessible portion of the at least one inflatable tube. In various embodiments, the second pouch is configured to store the second end of the USB extension cord.

In various embodiments, the second pouch is a second weather-resistant pouch.

In various embodiments, the first pouch includes a transparent plastic film or window configured to, once the solar powered USB charger is placed inside, expose photovoltaic cells of the solar powered USB charger to the sunlight.

In various embodiments, the solar powered USB charger is coupled to an upper, unobstructed portion of the at least one inflatable tube.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates an aircraft having an evacuation assembly, in accordance with various embodiments.

FIG. 2 illustrates an evacuation slide of an evacuation assembly in a deployed position, in accordance with various embodiments.

FIG. 3 illustrates a life raft in a deployed, or inflated, state, in accordance with various embodiments.

FIG. 4 illustrates a weatherproof or weather-resistant pouch, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As stated previously, typical aircraft emergency evacuation systems may often include inflatables. These inflatables may be inflated in an event of an emergency using an inflation system. In that regard, in an event of an emergency water landing, aircraft typically have one or more inflatables that may be deployed to hold evacuated passengers. While such inflatables may include beacons that may be utilized to identify a location of the inflatables once it is in the water, current inflatables have yet to embrace a paradigm shift towards “smart” technology. Over the past decades, the proliferation of mobile devices has skyrocketed from 0.7 billion in the early 2000s to over 6 billion today. Accordingly, current inflatables could be equipped with a charging devices so that mobile devices may establish and sustain emergency communications. This is especially important as more common mobile devices contain satellite communications technology for improved communications in sparsely populated areas.

Disclosed herein are systems and methods for a solar powered universal serial bus (USB) charger in an inflatable. In various embodiments, the inflatable may be an evacuation slide, a life raft, or a life jacket, among other inflatables. In various embodiments, the solar powered USB charger may be positioned at an upper, unobstructed location on the inflatable so that the inflatable is exposed to maximum direct sun light, i.e. not obstructed by passengers or canopies, among others. In various embodiments, the solar powered USB charger may be configured to fit within a pouch located at the upper, unobstructed location on the inflatable. In various embodiments, the pouch may be either weatherproof or weather-resistant. In various embodiments, responsive to the pouch being a weatherproof pouch, a first end of a USB extension cord may be coupled to the solar powered USB charger prior to the pouch being hermetically sealed and the second end of the USB extension cord may be located in a weather-resistant pouch located at a different location on the inflatable closer to the passengers. In various embodiments, responsive to the pouch being a weather-resistant pouch, a passenger may be able to access the solar powered USB charger and connect the passenger's mobile device to a charging cord connected to the solar powered USB charger and then close the weather-resistant pouch with the solar powered USB charger residing therein. In various embodiments, the pouches may be configured with a transparent plastic film or window so that, once the solar powered USB charger is placed inside, the photovoltaic cells of the solar powered USB charger are exposed to maximum direct sun light. In various embodiments, the pouches are configured to be bonded to an outer circumferential surface of a canopy support tube or inflatable border tube. In various embodiments, the solar powered USB charger may be configured with direct satellite connectivity to provide communication connectivity to the passenger's mobile device. In various embodiments, the solar powered USB charger may also be configured with a light to provide temporary light when required. In that regard, in various embodiments, any light provided by the solar powered USB charger may be programmed to turn off after a predetermined time so as to not drain batteries within the solar powered USB charger.

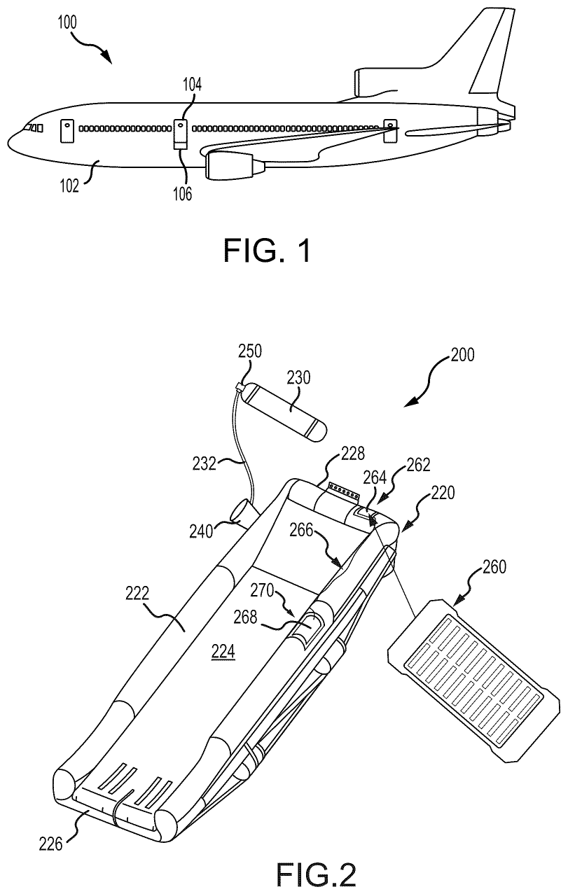

Referring now to FIG. 1, in accordance with various embodiments, an aircraft 100 is illustrated. Aircraft 100 may include a fuselage 102 having a plurality of exit doors, including an exit door 104. In various embodiments, an aircraft 100 may include one or more evacuation systems positioned near a corresponding exit door. In various embodiments, the aircraft 100 includes an evacuation system 106 positioned near an exit door 104. In various embodiments, in the event of an emergency, the exit door 104 may be opened by a passenger or crew member of the aircraft 100. In various embodiments, the evacuation system 106 may deploy in response to the exit door 104 being opened. It is contemplated and understood that the evacuation system 106 may deploy in response to other actions taken by a passenger or crew member such as, for example, depression of a button, actuation of a lever, or the like.

Referring now to FIG. 2, in accordance with various embodiments, an evacuation system is illustrated in a deployed state. In various embodiments, the evacuation system 200, which may be an evacuation system such as evacuation system 106 of FIG. 1, includes an evacuation slide 220 in a deployed, or inflated, state and a compressed gas tank 230 configured to deliver a pressurized gas to inflate the evacuation slide 220. In various embodiments, during deployment, an inflatable tube 222 (or a plurality of inflatable tubes) of the evacuation slide 220 is inflated using pressurized gas from a compressed gas tank 230. In various embodiments, the evacuation slide 220 may comprise a sliding surface 224 secured to the inflatable tube 222. In various embodiments, the evacuation slide 220 includes a toe end 226 and a head end 228 opposite toe end 226. In various embodiments, the head end 228 may be coupled to an aircraft structure (e.g., fuselage 102 in FIG. 1). In various embodiments, the sliding surface 224 extends from the head end 228 to the toe end 226. In various embodiments, the evacuation slide 220 is illustrated as a single lane slide. However, in various embodiments, the evacuation slide 220 may comprise any number of lanes.

In various embodiments, the compressed gas tank 230 is fluidly coupled to the evacuation slide 220. In various embodiments, the compressed gas tank 230 may be fluidly coupled to inflatable tube 222 via a hose, or conduit, 232. In various embodiments, the compressed gas tank 230 is coupled to the hose, or conduit, 232 via a regulator valve assembly 250. In various embodiments, evacuation system 200 may include an aspirator 240 fluidly coupled between compressed gas tank 230 and evacuation slide 220. In various embodiments, the aspirator 240 is configured to entrain ambient air with gas output from the compressed gas tank 230. In various embodiments, in response to deployment of the evacuation slide 220, the regulator valve assembly 250 may activate and release the gas flow from the compressed gas tank 230 into the aspirator 240, which may cause the aspirator 240 to draw in ambient air from the environment. The combination of the gas flow from the compressed gas tank 230 and the ambient air is then directed into the evacuation slide 220, thereby inflating the inflatable tube 222.

In various embodiments, the evacuation system 200 further includes a solar powered universal serial bus (USB) charger 260. In various embodiments, the solar powered USB charger 260 may be positioned at an upper, unobstructed location 262 of the evacuation slide 220 so that the inflatable is exposed to direct sun light, i.e. not obstructed by passengers or canopies, among other things. In various embodiments, the solar powered USB charger 260 may be configured to fit within a first pouch 264 located at the upper, unobstructed location 262 on the evacuation slide 220. In various embodiment, the first pouch 264 may be weatherproof or weather-resistant. In various embodiments, responsive to the first pouch 264 being a weatherproof, i.e. hermetically sealed, pouch, a first end of a USB extension cord 266 may be coupled to the solar powered USB charger 260 prior to the first pouch 264 being hermetically sealed and the second end of the USB extension cord 266 may be located in a second pouch 268 located at a different location 270 on the evacuation slide 220 closer to the passengers. In various embodiments, the second pouch 268 is configured to be weather resistant so that the second end of the USB extension cord 266 may be accessed. In various embodiments, responsive to the first pouch 264 being a weather-resistant pouch, a passenger may be able to access the solar powered USB charger 260 and connect the passenger's mobile device to a charging cord connected to the solar powered USB charger 260 directly and then close the first pouch 264 with the solar powered USB charger 260 residing therein.

In various embodiments, the solar powered USB charger 260 may also be configured with a light to provide temporary light when required. In that regard, in various embodiments, any light provided by the solar powered USB charger 260 may be programmed to turn off after a predetermined time so as to not drain batteries within the solar powered USB charger 260.

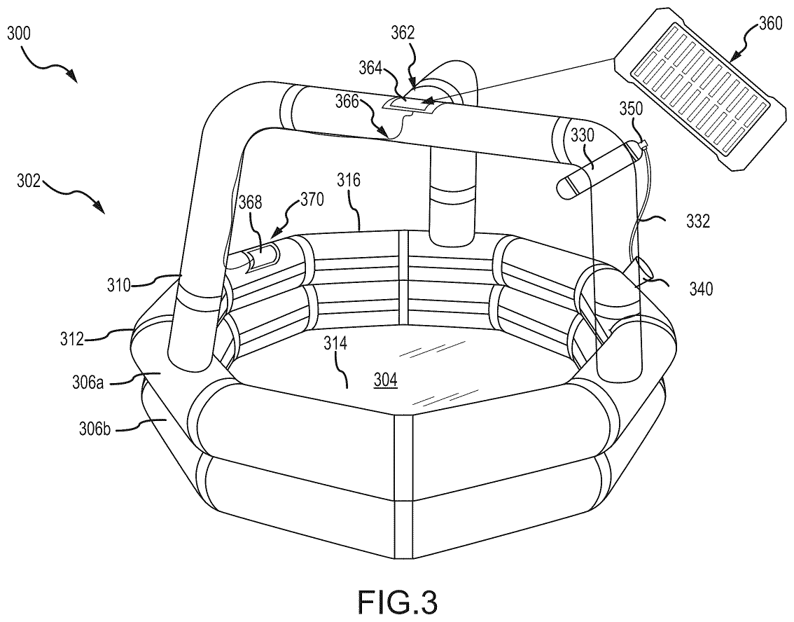

Referring now to FIG. 3, in accordance with various embodiments, a life raft is illustrated in a deployed, or inflated, state. In various embodiments, the life raft 300, which may be an evacuation system such as evacuation system 106 of FIG. 1, includes an inflatable structure 302. In various embodiments, the inflatable structure 302 may comprise a flexible, waterproof material such as a polyurethane polymer, polyvinylchloride polymer, or other suitable polymer. In various embodiments, the inflatable structure 302 may comprise a base 304 configured to support passengers and separate passengers from a body of water while the inflatable structure 302 is in operation. In various embodiments, the inflatable structure 302 may include one or more inflatable border tubes 306a, 306b. In various embodiments, the inflatable border tubes 306a, 306b may provide buoyancy to the inflatable structure 302 and may be mounted one on the other. In various embodiments, the inflatable border tubes 306a, 306b may provide a degree of redundancy in that each border tube may be independently capable of supporting the weight of the life raft 300 when filled to capacity with passengers. In various embodiments, the inflatable border tubes 306a, 306b may circumscribe the base 304. In various embodiments, the inflatable structure 302 may generally comprise a hexagonal shape. That is, in various embodiments, the inflatable border tubes 306a, 306b may define a hexagonal shape. However, in various embodiments, the inflatable structure 302 may generally comprise a circular shape, a rectangular shape, a pentagonal shape, an octagonal shape, or any other desired shape.

In various embodiments, the inflatable structure 302 may further include an inflatable canopy support tube 310 (also referred to an outer tangent support tube). In various embodiments, the inflatable canopy support tube 310 may be oriented as an arch extending between opposing sides of the life raft 300. In accordance with various embodiments, the inflatable canopy support tube 310 is fluidly coupled to the inflatable border tube 306a. In this regard, the inflatable border tube 306a and the inflatable canopy support tube 310 may be part of one, interconnected chamber that fills with gas in response to deployment of the life raft 300.

In accordance with various embodiments, the inflatable canopy support tube 310 is attached to an outer portion 312 of the inflatable border tube 306a. In various embodiments, the outer portion 312 of the inflatable border tube 306a is generally perpendicular to a first surface 314 of the base 304 and/or to an uppermost point 316 of the inflatable border tube 306a. Stated differently, in various embodiments, a line tangent to the outer portion 312 is approximately perpendicular to the first surface 314 of the base 304 and/or to a line tangent to the uppermost point 316 of the inflatable border tube 306a. In various embodiments, as used in the previous context only, the term “approximately” means ±5°. In various embodiments, the first surface 314 of the base 304 is oriented away from the water, when the life raft 300 is in use. In various embodiments, the uppermost point 316 of the inflatable border tube 306a is oriented in the same direction as the first surface 314. In various embodiments, the inflatable canopy support tube 310 may be attached to the inflatable border tube 306a at point that is approximately 90°about the circumference of the inflatable border tube 306a from the uppermost point 316. As used in the previous context only, the term “approximately”means ±5°.

During deployment, in various embodiments, the inflatable border tubes 306a, 306b and the inflatable canopy support tube 310 are inflated using pressurized gas from the compressed gas tank 330. In various embodiments, the compressed gas tank 330 is fluidly coupled to the evacuation slide 320. In various embodiments, the compressed gas tank 330 may be fluidly coupled to the inflatable border tubes 306a, 306b and the inflatable canopy support tube 310 via a hose, or conduit, 332. In various embodiments, the compressed gas tank 330 is coupled to the hose, or conduit, 332 via a regulator valve assembly 350. In various embodiments, the life raft 300 may include an aspirator 340 fluidly coupled between the compressed gas tank 330 and the evacuation slide 320. In various embodiments, the aspirator 340 is configured to entrain ambient air with gas output from the compressed gas tank 330. In various embodiments, in response to deployment of the inflatable structure 302, the regulator valve assembly 350 may activate and release the gas flow from the compressed gas tank 330 into the aspirator 340, which may cause the aspirator 340 to draw in ambient air from the environment. the inflatable structure 302. In various embodiments, the combination of the gas flow from the compressed gas tank 330 and the ambient air is then directed into the inflatable structure 302, thereby inflating inflatable the inflatable border tubes 306a, 306b and the inflatable canopy support tube 310.

In various embodiments, the life raft 300 further includes a solar powered universal serial bus (USB) charger 360. In various embodiments, the solar powered USB charger 360 may be positioned at an upper, unobstructed location 362 of the inflatable structure 302 so that the inflatable is exposed to maximum direct sun light, i.e. not obstructed by passengers or canopies, among others. In various embodiments, the solar powered USB charger 360 may be configured to fit within a first pouch 364 located at the upper, unobstructed location 362 on the inflatable structure 302. In various embodiments, the first pouch 364 may be either weatherproof or weather-resistant. In various embodiments, responsive to the first pouch 364 being a weatherproof pouch, a first end of a USB extension cord 366 may be coupled to the solar powered USB charger 360 prior to the first pouch 364 being hermetically sealed and the second end of the USB extension cord 366 may be located in a second pouch 368 located at a different location 370 on the inflatable structure 302 closer to the passengers. In various embodiments, the second pouch 368 is configured to be weather resistant so that the second end of the USB extension cord 366 may be accessed. In various embodiments, responsive to the first pouch 364 being a weather-resistant pouch, a passenger may be able to access the solar powered USB charger 360 and connect the passenger's mobile device to a charging cord connected to the solar powered USB charger 360 directly and then close the first pouch 364 with the solar powered USB charger 360 residing therein.

In various embodiments, the solar powered USB charger 360 may be configured with direct satellite connectivity to provide connectivity to provide communication connectivity to the passenger's mobile device. In various embodiments, the solar powered USB charger 360 may also be configured with a light to provide temporary light when beneficial. In that regard, in various embodiments, any light provided by the solar powered USB charger 360 may be programmed to turn off after a predetermined time so as to not drain batteries within the solar powered USB charger 360.

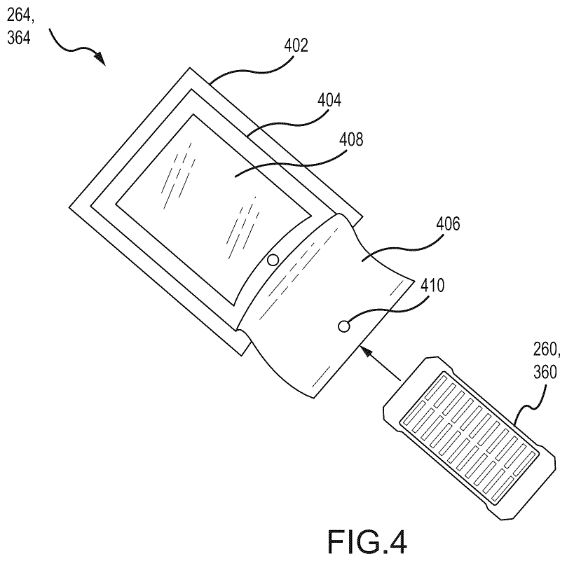

Referring now to FIG. 4, in accordance with various embodiments, a weatherproof or weather-resistant pouch is illustrated. In various embodiments, the first pouch 264, 364 includes a base patch 402 configured to bond to an outer surface of the evacuation slide or inflatable structure. In various embodiments, a pocket 404 with a flap 406 is coupled to the base patch 402. In various embodiments, the pocket 404 includes a transparent plastic film or window 408 that is configured to, once the solar powered USB charger 260, 360 is placed inside the pocket 404, expose photovoltaic cells of the solar powered USB charger 260, 360 to maximum direct sun light. In various embodiments, the first pouch 264, 364 may be either weatherproof or weather-resistant.

In various embodiments, responsive to the first pouch 264, 364 being a weatherproof pouch, a first end of a USB extension cord may be coupled to the solar powered USB charger 260, 360 prior to the first pouch 264, 364 being hermetically sealed and the second end of the USB extension cord may be located in a second pouch located at a different location of the evacuation slide or inflatable structure closer to the passengers. In various embodiments, responsive to the first pouch 264, 364 being a weather-resistant pouch, passengers may be able to access the solar powered USB charger 260, 360 and connect a charging cord to the solar powered USB charger 260, 360 directly and then close the first pouch 264, 364 with the solar powered USB charger 260, 360 residing therein using a sealing structure 410. In various embodiments, the sealing structure may be a weather-resistant hook and loop mechanism or a weather-resistant zipper mechanism, among others. It is noted that in various embodiments, the second pouch 268, 368 may be configured similar to the first pouch 264, 364.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more. ” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S. C. 112(f) unless the element is expressly recited using the phrase “means for. ” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A life raft, comprising:
at least one inflatable tube;
an inflatable canopy support tube coupled to the at least one inflatable tube; and
a solar powered universal serial bus (USB) charger, the solar powered USB charger coupled to the inflatable canopy support tube, wherein the solar powered USB charger is configured to store a charge by being exposed to sunlight and wherein the solar powered USB charger is configured to charge a mobile device responsive to being connected to the mobile device.

2. The life raft of claim 1, further comprising:
a first pouch, wherein the first pouch is coupled to an upper, unobstructed portion of the inflatable canopy support tube and wherein the first pouch is configured to house the solar powered USB charger.

3. The life raft of claim 2, wherein the first pouch is at least one of a weather-resistant pouch or a weatherproof pouch.

4. The life raft of claim 3, wherein, responsive to the first pouch being a first weather-resistant pouch, the solar powered USB charger is accessible via a flap and wherein the flap is configured to provide weather-resistance when sealed via a seal.

5. The life raft of claim 4, wherein the seal is at least one of a weather-resistant hook and loop mechanism or a weather-resistant zipper mechanism.

6. The life raft of claim 3, wherein, responsive to the first pouch being the weatherproof pouch, a first end of a USB extension cord is coupled to the solar powered USB charger and, once the solar powered USB charger is placed in the weatherproof pouch, the weatherproof pouch is hermetically sealed leaving a second end of the USB extension cord accessible.

7. The life raft of claim 6, further comprising:
a second pouch, wherein the second pouch is coupled to an accessible portion of the at least one inflatable tube and wherein the second pouch is configured to store the second end of the USB extension cord.

8. The life raft of claim 7, wherein the second pouch is a second weather-resistant pouch.

9. The life raft of claim 2, wherein the first pouch comprises a transparent plastic film or window configured to, once the solar powered USB charger is placed inside, expose photovoltaic cells of the solar powered USB charger to the sunlight.

10. The life raft of claim 1, wherein the solar powered USB charger is coupled to an upper, unobstructed portion of the inflatable canopy support tube.

11. An evacuation slide, comprising:
at least one inflatable tube; and
a solar powered universal serial bus (USB) charger, the solar powered USB charger coupled to one of the at least one inflatable tube, wherein the solar powered USB charger is configured to store a charge by being exposed to sunlight and wherein the solar powered USB charger is configured to charge a mobile device responsive to being connected to the mobile device.

12. The evacuation slide of claim 11, further comprising:
a first pouch, wherein the first pouch is coupled to an upper, unobstructed portion of the at least one inflatable tube and wherein the first pouch is configured to house the solar powered USB charger.

13. The evacuation slide of claim 12, wherein the first pouch is at least one of a weather-resistant pouch or a weatherproof pouch.

14. The evacuation slide of claim 13, wherein, responsive to the first pouch being a first weather-resistant pouch, the solar powered USB charger is accessible via a flap and wherein the flap is configured to provide weather-resistance when sealed via a seal.

15. The evacuation slide of claim 14, wherein the seal is at least one of a weather-resistant hook and loop mechanism or a weather-resistant zipper mechanism.

16. The evacuation slide of claim 13, wherein, responsive to the first pouch being the weatherproof pouch, a first end of a USB extension cord is coupled to the solar powered USB charger and, once the solar powered USB charger is placed in the weatherproof pouch, the weatherproof pouch is hermetically sealed leaving a second end of the USB extension cord accessible.

17. The evacuation slide of claim 16, further comprising:
a second pouch, wherein the second pouch is coupled to an accessible portion of the at least one inflatable tube and wherein the second pouch is configured to store the second end of the USB extension cord.

18. The evacuation slide of claim 17, wherein the second pouch is a second weather-resistant pouch.

19. The evacuation slide of claim 12, wherein the first pouch comprises a transparent plastic film or window configured to, once the solar powered USB charger is placed inside, expose photovoltaic cells of the solar powered USB charger to the sunlight.

20. The evacuation slide of claim 11, wherein the solar powered USB charger is coupled to an upper, unobstructed portion of the at least one inflatable tube.
